(19) United States
(12) Patent Application Publication
(10) Pub. No.: US 2026/0313270 A1
(43) Pub. Date: Oct. 8, 2026

(54) RADIATION DETECTOR AND RADIATION DETECTION SYSTEM

(71) Applicant: CANON KABUSHIKI KAISHA, Tokyo (JP)

(72) Inventor: MASATO AIHARA, Kanagawa (JP)

(21) Appl. No.: 19/575,053

(22) Filed: Mar. 23, 2026

(30) Foreign Application Priority Data
Apr. 4, 2025 (JP) 2025-062550

(51) Int. Cl. H04N 25/78; H04N 25/673; H04N 25/771

(52) U.S. Cl. CPC H04N 25/78; H04N 25/673; H04N 25/771

(57) ABSTRACT

A radiation detector including pixels outputting pixel signals and an AD converter AD-converting the pixel signals is provided. The AD converter includes a comparator comparing the pixel signal with a threshold and operates in a plurality of modes. The modes include a mode of performing AD conversion by using a first reference signal in a case where the pixel signal is smaller than the threshold and performing AD conversion by using a second reference signal in a case where the pixel signal is larger than the threshold. The first reference signal temporal changes in a first voltage range, the second reference signal temporal changes in a second voltage range, an upper limit of the first voltage range is smaller than a lower limit of the second voltage range, and the signal threshold is set between the upper limit and the lower limit.

### BACKGROUND

### Field of the Technology

The present disclosure relates to a radiation detector and a radiation detection system.

### Description of the Related Art

A radiation detector that converts radiation such as X-rays and electron beams into electrical signals can obtain a radiation image with reduced noise by removing background components caused by a dark current flowing in a sensor and the like from the signal obtained by the sensor. Japanese Patent Laid-Open No. 2008-524874 discloses that an X-ray imaging system that detects X-rays with a CMOS image sensor is configured to correct the image signals of image frames by using the correction coefficients acquired by using the image signals of different image frames.

A background component such as a dark current can change with a change in temperature. A background component changes as the temperature of a radiation detector rises with the lapse of time as in a case where imaging is continuously performed concurrently with irradiation with radiation. In this case, the radiation image obtained by correction using the background components acquired in advance may deteriorate in image quality.

### SUMMARY

Some embodiments of the present disclosure provide a technique advantageous in improving the image quality of a radiation image.

According to some embodiments, a radiation detector comprising a plurality of pixels configured to output pixel signals in accordance with incident radiation and an A/D converter configured to A/D-convert the pixel signals, wherein the A/D converter includes a comparator configured to compare the pixel signal with a signal threshold and is configured to operate in a plurality of modes, the plurality of modes includes a first mode of performing A/D conversion of the pixel signal by using a first reference signal in a case where the pixel signal is smaller than the signal threshold and performing A/D conversion of the pixel signal by using a second reference signal in a case where the pixel signal is larger than the signal threshold, the first reference signal is a signal that temporally changes in a first voltage range, and the second reference signal is a signal that temporally changes in a second voltage range, an upper limit value of the first voltage range is smaller than a lower limit value of the second voltage range, and the signal threshold is set between the upper limit value and the lower limit value, is provided.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram showing a configuration example of a radiation detector according to the present embodiment;

FIG. 2 is a circuit diagram showing a configuration example of a pixel of the radiation detector according to the present embodiment;

FIG. 3 is a view for explaining a pixel signal from the radiation detector according to the present embodiment;

FIG. 4 is a graph showing the histogram of a pixel output value from the radiation detector according to the present embodiment;

FIG. 5 is a block diagram showing a configuration example of an A/D converter of the radiation detector according to the present embodiment;

FIG. 6 is a graph for explaining a signal processing example of the radiation detector according to the present embodiment;

FIG. 7 is a graph showing a binarization method of the radiation detector according to the present embodiment;

FIG. 8 is a flowchart showing a processing example of the radiation detector according to the present embodiment;

FIG. 9 is a graph for explaining a signal processing example of the radiation detector according to the present embodiment;

FIG. 10 is a flowchart showing a processing example of the radiation detector according to the present embodiment;

FIGS. 11A and 11B are views for explaining a signal processing example of the radiation detector according to the present embodiment;

FIG. 12 is a block diagram showing a configuration example of the radiation detector according to the present embodiment;

FIG. 13 is a block diagram showing a configuration example of a radiation detection system including the radiation detector according the present embodiment;

FIG. 14 is a flowchart for explaining a signal processing example of the radiation detector according to the present embodiment; and

FIGS. 15A and 15B are schematic views respectively showing a configuration example of equipment as a radiation detection system including the radiation detector according to the present embodiment and a configuration example of a transmission electron microscope as a radiation detection system including the radiation detector according to the present embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

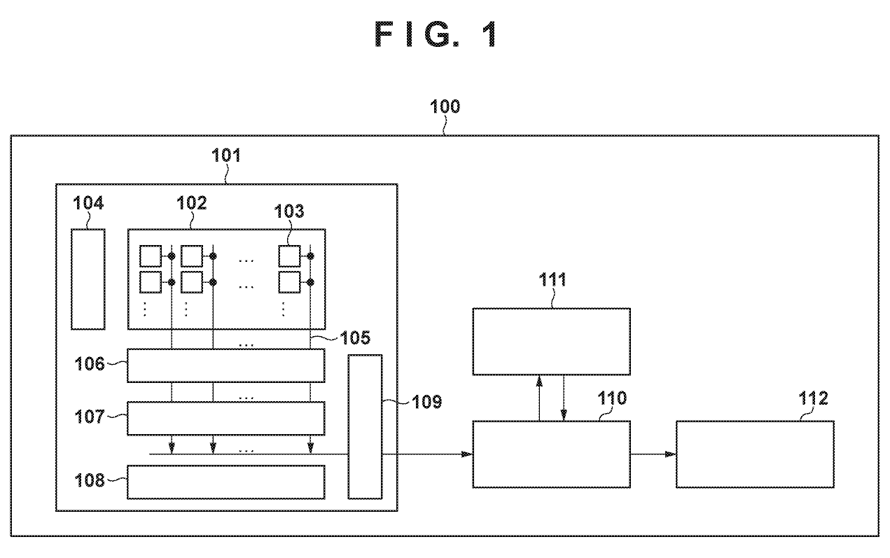

A radiation detector according to an embodiment of the present disclosure and a radiation detection system using the radiation detector will be described with reference to FIGS. 1 to 15A and 15B. In the following description, "radiation" is a concept including electromagnetic radiation (X-rays, gamma rays, and the like), particle radiation (electron rays, proton rays, neutron rays, alpha rays, and the like), and non-ionizing radiation (radio waves, microwaves, infrared rays, visible rays, and the like). The term "radiation detection system" indicates a system in general which is configured to acquire an image of an imaging target (an object, a patient in a case of a medical imaging system, or the like) as electronic data by using radiation. The term "image" indicates a still image or moving image.

Each embodiment described below exemplifies a radiation detector including a conversion element that converts incident radiation into electric charge and a radiation detection system using the radiation detector. FIG. 1 is a block diagram showing a schematic configuration example of a radiation detector 100 according to the present embodiment. The radiation detector 100 can include an imaging unit 101, an output signal processor 110, a memory 111, an external interface (external I/F) 112.

The imaging unit 101 can include a pixel array 102 including a plurality of pixels 103 arrayed in a matrix pattern, a vertical scanning circuit 104, a vertical signal line 105, a column signal processing circuit 106, a column memory 107, a horizontal scanning circuit 108, and a signal processing circuit 109. The vertical scanning circuit 104, the vertical signal line 105, the column signal processing circuit 106, the column memory 107, and the horizontal scanning circuit 108 operate in cooperation with each other and constitute an example of a readout circuit that reads out a pixel signal from each pixel 103 of the pixel array 102 for each frame. The signal processing circuit 109 is an example of a processing circuit that processes a pixel signal read out by the readout circuit. The imaging unit 101 is, for example, a CMOS image sensor that detects radiation.

The pixels 103 constituting the pixel array 102 each convert incident radiation into electric charge. The configuration of the pixel 103 will be described later. The vertical scanning circuit 104 selects and sequentially scans pixel rows of the pixel array 102 from which pixel signals are output. The vertical signal line 105 transfers a pixel signal from the pixel 103 selected by the vertical scanning circuit 104. The column signal processing circuit 106 processes the pixel signal input from the vertical signal line 105. The processing performed by the column signal processing circuit 106 includes analog-digital (A/D) conversion. Accordingly, the column signal processing circuit 106 includes an A/D converter as will be described later. The column memory 107 holds the digital signal output from the column signal processing circuit 106. The horizontal scanning circuit 108 sequentially reads out digital signals for each column by scanning the column signal processing circuit 106 or the column memory 107 in the pixel column direction. The signal processing circuit 109 is an output circuit that processes the digital signal read out from the column signal processing circuit 106 or the column memory 107 and outputs the processed signal to outside the imaging unit 101.

The output signal processor 110 arithmetically processes the signal output from the imaging unit 101. The memory 111 is a data holding unit (storage area) for arithmetic processing by the output signal processor 110 and holds data as a processing target or predetermined data. The signal output from the output signal processor 110 is output to outside the radiation detector 100 via the external I/F UNIT 112.

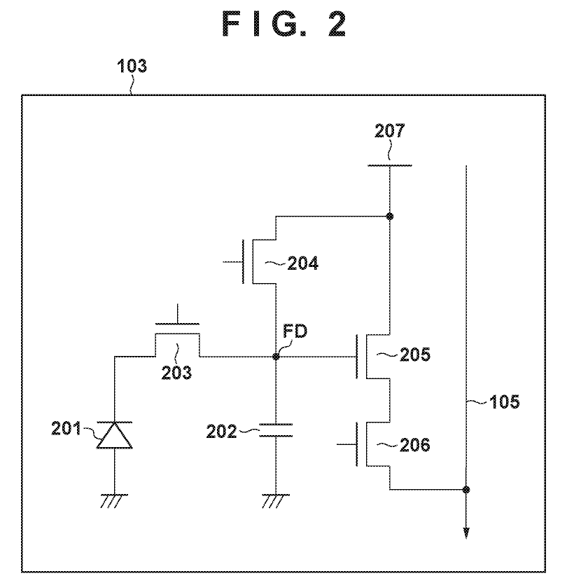

FIG. 2 shows a configuration example of the pixel 103 shown in FIG. 1. The pixel 103 can include a photodiode 201, a floating diffusion capacitance 202, a transfer transistor 203, a reset transistor 204, an amplification transistor 205, and a pixel selection transistor 206.

The photodiode 201 is a conversion element that converts incident radiation into electric charge. The anode of the photodiode 201 is connected to a reference voltage node, and the cathode is connected to the source of the transfer transistor 203. The drain of the transfer transistor 203 is connected to the source of the reset transistor 204 and the gate of the amplification transistor 205. A connection node FD between the drain of the transfer transistor 203, the source of the reset transistor 204, and the gate of the amplification transistor 205 is a so-called floating diffusion unit. The floating diffusion unit includes a capacitance component (the floating diffusion capacitance 202) and has a function as an electric charge holding unit. In the present embodiment, the conversion element is, for example, the photodiode 201 formed on a semiconductor substrate such as a silicon substrate but is not limited thereto. For example, a conversion element formed from cadmium telluride or cadmium zinc telluride may be used instead of the photodiode 201.

The drain of the reset transistor 204 and the drain of the amplification transistor 205 are connected to a power supply voltage node 207 to which a power supply voltage is supplied. The source of the amplification transistor 205 is connected to the drain of the pixel selection transistor 206. The source of the pixel selection transistor 206 is connected to the vertical signal line 105. The vertical signal line 105 is connected to a current source.

Signal lines that transmit control signals from the vertical scanning circuit 104 are respectively connected to the gates of the transfer transistor 203, the reset transistor 204, and the pixel selection transistor 206. Each signal line is a signal line common to a row of the pixel array 102 to which the pixels 103 belong.

When radiation enters the pixel 103, the photodiode 201 converts the radiation into electric charge (signal electric charge) and accumulates the electric charge. The transfer transistor 203 transfers the signal electric charge accumulated in the photodiode 201 to the floating diffusion unit (the connection node FD) based on the control signal supplied from the vertical scanning circuit 104. The floating diffusion unit holds the electric charge transferred from the photodiode 201 and holds a voltage corresponding to the amount of transferred electric charge upon electric charge/voltage conversion by the floating diffusion capacitance 202.

The amplification transistor 205 amplifies the pixel signal based on the electric charge held by the floating diffusion unit (the connection node FD) and outputs the amplified pixel signal to the pixel selection transistor 206. The pixel selection transistor 206 outputs a pixel signal from the amplification transistor 205 to the vertical signal line 105 based on the control signal supplied from the vertical scanning circuit 104. This causes the pixel 103 to output a pixel signal corresponding to the incident radiation. The reset transistor 204 resets the floating diffusion unit to a voltage corresponding to the power supply voltage based on the control signal supplied from the vertical scanning circuit 104. The pixel 103 may be configured such that the transfer transistor 203 is omitted, and the photodiode 201 and the floating diffusion capacitance 202 are directly connected to each other.

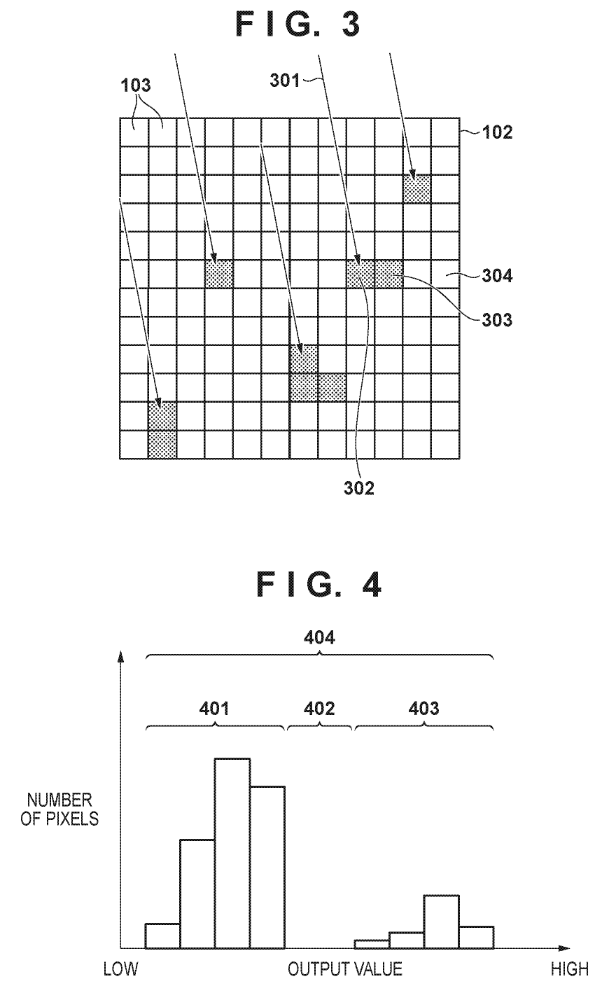

FIG. 3 is a schematic view showing an output from each pixel 103 when the pixel array 102 is irradiated with radiation 301. The pixels 103 irradiated with the radiation 301 are indicated with color, and the pixels 103 not irradiated with the radiation 301 are indicated without color. Examples of the types of radiation include, for example, X-rays, electron beams, and gamma rays. A proper conversion element such as the photodiode 201 or a proper wavelength conversion material such as a scintillator may be used in accordance with the type of radiation to be applied.

FIG. 4 is a graph showing an example of expressing the output values of pixel signals in one frame of the pixel array 102 in histogram form. The abscissa represents the output value of the pixel signal output from each pixel 103, and the ordinate represents the number of pixels. The histograms are distributed in three ranges, namely, a first pixel signal range 401, a second pixel signal range 403 that does not overlap the first pixel signal range 401, and a third pixel signal range 402 between the first pixel signal range 401 and the second pixel signal range 403. Accordingly, the voltage range of a ramp signal at the time of A/D conversion of the pixel signal output from the arbitrary pixel 103 needs to be a range including the first pixel signal range 401, the second pixel signal range 403, and the third pixel signal range 402 as in the case of a pixel signal range 404. In this case, the upper limit value of the first pixel signal range 401 is smaller than the lower limit value of the second pixel signal range 403. The upper limit value of the third pixel signal range 402 is equal to or smaller than the lower limit value of the second pixel signal range 403. The lower limit value of the third pixel signal range 402 is equal to or larger than the upper limit value of the first pixel signal range 401. The first pixel signal range 401 is premised on the range of the output values of pixel signals from the pixels 103 not irradiated with radiation. The second pixel signal range 403 is premised on the range of the output values of pixel signals from the pixels 103 irradiated with radiation.

In this case, a pixel signal is a signal output from the pixel 103 in accordance with the signal electric charge generated in accordance with incident radiation. The pixel signal can change depending on radiation irradiation conditions such as the type of radiation and acceleration energy, the structure of a conversion element such as the photodiode 201, the thickness of the substrate of the pixel array 102, and the like. If the energy of radiation is large, generated signal electric charge has a statistical probability distribution and hence is not constant. In addition, applied radiation sometimes generates electric charge that leaks into the adjacent pixels 103 in the substrate of the pixel array 102. In such a case, as in the case of pixels 302 and 303 shown in FIG. 3, a pixel signal is sometimes generated in accordance with radiation entering across a plurality of adjacent pixels.

In contrast to this, the value of a pixel signal from a pixel (for example, a pixel 304 in FIG. 3) not irradiated with radiation is equal to that of the pixel signal read out without irradiation with radiation. Note, however, that the signal value does not become zero but becomes the output obtained by superimposing a dark current occurring in the photodiode 201, noise or shading originating from the circuit, and the like. For this reason, values in the first pixel signal range 401 have a width. A component occurring with or without irradiation with radiation is called a background component. A background component can interfere with the detection of a signal component originating from radiation and lead to a reduction in the image quality of image data acquired by the radiation detector 100.

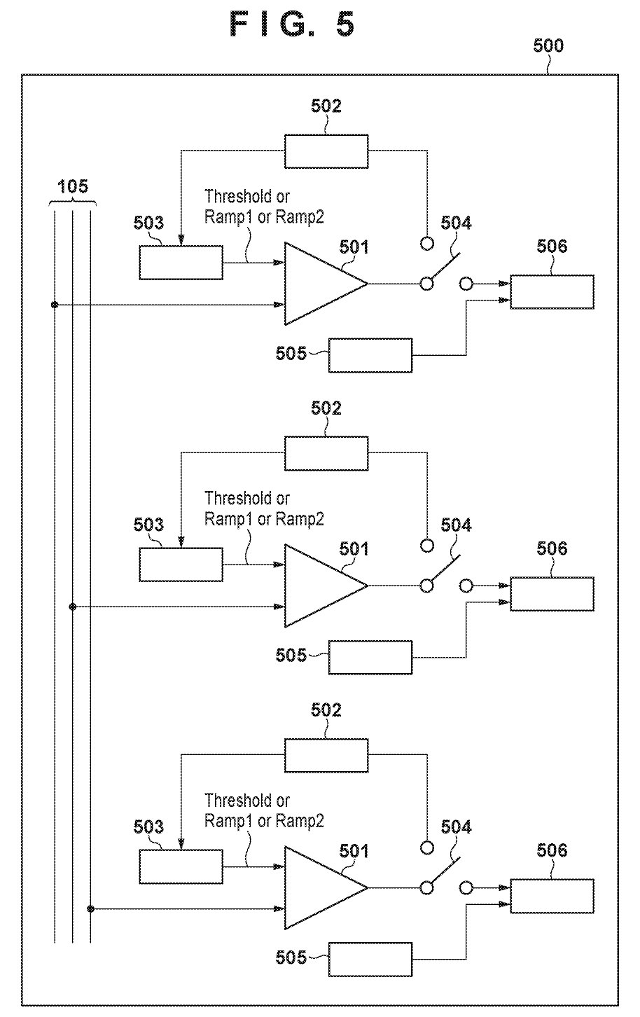

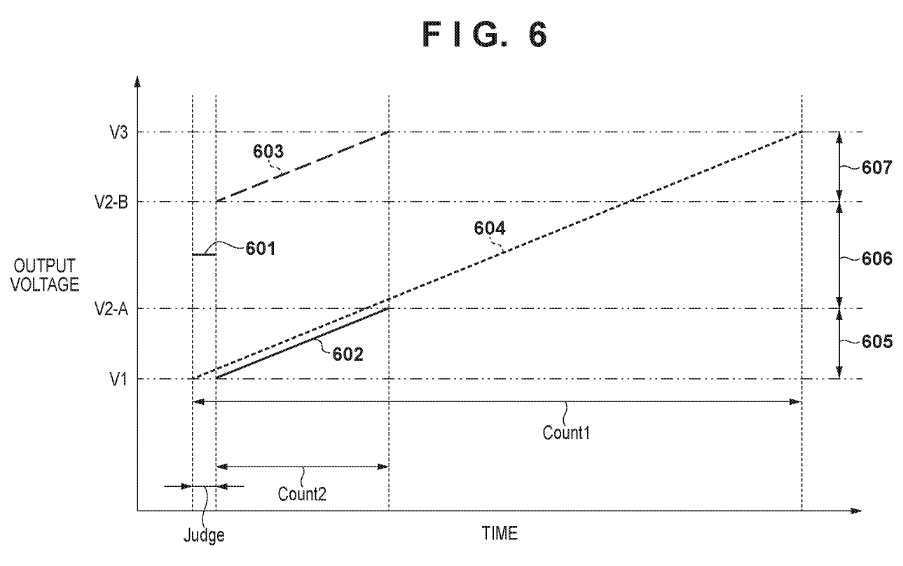

FIG. 5 shows a configuration example of an A/D converter 500 included in the column signal processing circuit 106. The A/D converter 500 can include a comparator 501, a determination unit 502, a reference signal generating circuit 503, a changeover switch 504, a counter 505, and a digital memory 506.

The comparator 501 can include two input nodes and one output node. A pixel signal is supplied from the vertical signal line 105 to one input node of the comparator 501. Although details will be described later, the A/D converter 500 (the radiation detector 100) is configured to be able to operate in a plurality of modes. In a high-speed mode of the plurality of modes, any one of a signal threshold Threshold, a ramp signal Ramp1, and a ramp signal Ramp2 is supplied from the reference signal generating circuit 503 to the other input node of the comparator 501.

In the high-speed mode, first of all, the comparator 501 outputs an L-level signal if the level of the signal threshold Threshold output from the reference signal generating circuit 503 is lower than the level of the pixel signal supplied from the vertical signal line 105. The comparator 501 outputs an H-level signal if the level of the signal threshold Threshold output from the reference signal generating circuit 503 is higher than the level of the pixel signal supplied from the vertical signal line 105. The determination unit 502 performs control so that the reference signal generating circuit 503 outputs the ramp signal Ramp1 as a reference signal if the output from the comparator 501 is an L-level signal. The determination unit 502 performs control so that the reference signal generating circuit 503 outputs the ramp signal Ramp2 as a reference signal if the output from the comparator 501 is an H-level signal.

The comparator 501 then outputs an L-level signal if the level of the ramp signal Ramp1 or the ramp signal Ramp2 output from the reference signal generating circuit 503 is lower than the level of the pixel signal supplied from the vertical signal line 105. The comparator 501 then outputs an H-level signal if the level of the ramp signal Ramp1 or the ramp signal Ramp2 output from the reference signal generating circuit 503 is higher than the level of the pixel signal supplied from the vertical signal line 105. The changeover switch 504 is synchronous with the reference signal generating circuit 503. In a case where the reference signal generating circuit 503 outputs the signal threshold Threshold, the changeover switch 504 is connected to the input portion of the determination unit 502. In a case where the reference signal generating circuit 503 outputs the ramp signal Ramp1 or the ramp signal Ramp2, the changeover switch 504 is connected to the input portion of the digital memory 506.

The counter 505 starts a counting operation in synchronism with the timing when the signal level of the ramp signal Ramp1 or Ramp2 supplied from the reference signal generating circuit 503 starts to change. The counter 505 has a function of outputting, to the digital memory 506, a count signal indicated by a count value at the timing when an output from the comparator 501 switches from L level to H level. The digital memory 506 holds the count signal input from the counter 505.

FIG. 6 is a timing chart for explaining the operation of the reference signal generating circuit 503. The abscissa represents the time, and ordinate represents the output voltage of the reference signal generating circuit 503. In this case, the range from a voltage V1 to a voltage V2-A is defined as a first voltage range 605, the range from a voltage V2-B to a voltage V3 is defined as a second voltage range 607, and the range from the voltage V2-A to the voltage V2-B is defined as a third voltage range 606. The reference signal generating circuit 503 of the A/D converter 500 can operate in a plurality of modes including a normal mode and a high-speed mode. A ramp signal 604 indicates a ramp voltage at the time of performing A/D conversion in the normal mode. In the normal mode, the reference signal generating circuit 503 sweeps ramp signals in the voltage ranges respectively including the first voltage range 605, the second voltage range 607, and the third voltage range 606. The ramp signal 604 is a signal that temporally changes in a continuous voltage range including the first voltage range 605 and the second voltage range 607.

On the other hand, in the high-speed mode, the reference signal generating circuit 503 generates a ramp signal 602 or a ramp signal 603 different from the ramp signal 604. The ramp signals 602 and 603 shown in FIG. 6 indicate ramp voltages used in the high-speed mode. The ramp signals 602 and 603 respectively correspond to the ramp signals Ramp1 and Ramp2 described above. The reference signal generating circuit 503 outputs a signal threshold 601 in a period Judge. If the level of the signal threshold 601 is higher than that of a signal from the vertical signal line 105, the reference signal generating circuit 503 sweeps the ramp signal 602 in the first voltage range 605 in a period Count2 under the control of the determination unit 502. The ramp signal 602 is a signal that temporally changes in the first voltage range 605. In contrast to this, if the level of the signal threshold 601 is lower than that of a signal from the vertical signal line 105, the reference signal generating circuit 503 sweeps the ramp signal 603 in the second voltage range 607 under the control of the determination unit 502. The ramp signal 603 is a signal that temporally changes in the second voltage range 607. In this case, the signal threshold 601 is set to a voltage value in the third voltage range 606 between the upper limit value of the first voltage range 605 and the lower limit value of the second voltage range 607.

In the example shown in FIG. 6, the gradients of the voltages of the ramp signals 602 and 603 with respect to the time in the high-speed mode are almost equal to the gradient of the voltage of the ramp signal 604 with respect to the time in the normal mode. In this case, "almost equal" indicates that the difference between them falls within the ranges of differences originating from variations in parasitic capacitance and parasitic resistance at the time of design, individual differences in mass production, and the like. These ranges empirically fall within ±5%.

As described above, the radiation detector 100 according to the present embodiment can implement imaging in the normal mode and fast imaging in the high-speed mode using the same imaging unit 101 by drive switching. Although details will be described later, for example, setting the first voltage range 605, the second voltage range 607, and the third voltage range 606 in the normal mode under proper conditions can implement A/D conversion upon narrowing the voltage ranges to voltage ranges necessary for binarization in the high-speed mode, thereby implementing fast imaging.

In the high-speed mode according to the present embodiment, the first pixel signal range 401 and the second pixel signal range 403 are assumed to respectively correspond to the first voltage range 605 and the second voltage range 607. The first voltage range 605 is the range of the output values of pixel signals from the pixels 103 not irradiated with radiation and corresponds to background components. The second voltage range 607 is the range of the output values of pixel signals from the pixels 103 irradiated with radiation and corresponds to image signal components. The pixel signal output from the pixel 103 is compared with the signal threshold 601 and A/D-converted by using either the ramp signal 602 or the ramp signal 603. That is, using the ramp signal 602 for the output value of one pixel signal can acquire a background component, and using the ramp signal 603 for the same output value can acquire an image signal component. The third pixel signal range 402 is assumed to correspond to the third voltage range 606. In binarized counting depending on whether radiation enters, in particular, a background component may be acquired, and an A/D conversion value near a determination threshold 701 for counting may be obtained. Accordingly, the third voltage range 606 where no A/D conversion is performed may be present between the first voltage range 605 and the second voltage range 607.

As described above, in the normal mode, A/D conversion is performed in a period Count1, whereas in the high-speed mode, A/D conversion is performed in the period Judge and a period Count2. In the high-speed mode, A/D conversion is performed in a voltage range narrower than that in the normal mode in accordance with the magnitude of the output value of a pixel signal. This makes it possible to perform faster A/D conversion in the high-speed mode than in the normal mode even with the period Judge in which a pixel signal is compared with the signal threshold Threshold.

In this case, even in a case where the signal threshold 601 is equal to the upper limit value of the first voltage range 605 or the lower limit value of the second voltage range 607, and the third voltage range 606 does not exist, A/D conversion is performed by using only one of the first voltage range 605 and the second voltage range 607 in the high-speed mode. Accordingly, even in such a case, faster driving can be implemented in the high-speed mode than in the normal mode.

In the high-speed mode according to the present embodiment, the first voltage range 605 is swept as the ramp signal 602, and the second voltage range 607 is swept as the ramp signal 603. That is, a background component and an image signal component can be acquired within the same frame. That is, it is possible to calculate a background component having simultaneity with imaging of an imaging target. This allows the radiation detector 100 according to the present embodiment to perform fast reading and calculate a background component having simultaneity with imaging of an imaging target.

For example, in the high-speed mode, the signal processing circuit 109 may calculate correction data by subtracting a background component from a pixel signal having undergone A/D conversion using the ramp signal 603. In this case, the radiation detector 100 can also output the correction data to the outside. For example, the signal processing circuit 109 corrects, based on a pixel signal A/D-converted by using the ramp signal 602, a pixel signal, of the pixel signals output from the plurality of pixels 103 in one frame, which is A/D-converted by using the ramp signal 603. For example, the signal processing circuit 109 may use, as a background component, a mode value, a median value, or an average value of a plurality of pixel signals A/D-converted by using the ramp signal 602. Instead of the signal processing circuit 109, the output signal processor 110 may correct a background component. As described above, the radiation detector 100 can provide the data of a background component and the net image data from which the background component is removed to, for example, another apparatus of the radiation detection system including the radiation detector 100.

In this manner, the radiation detector 100 can remove a background component at the time of imaging without using a calibration method, such as acquiring a pixel signal in a state in which no radiation is applied to acquire a background component at a time different from the time of imaging of an imaging target. However, this does not preclude the concurrent use of a calibration method of removing noise other than a background component removed by the method according to the present embodiment.

The background components of the pixel signals output from the plurality of pixels 103 can change due to various reasons. For example, a background component varies due to a change in dark current occurring in the pixel 103 due to, for example, a change in environmental temperature during imaging and a temperature change accompanying the operation of the radiation detector 100. The radiation detector 100 according to the present embodiment can acquire a background component having simultaneity with imaging even at the time of imaging which tends to have a problem with temporal variations in background component and hence can obtain image data with higher accuracy.

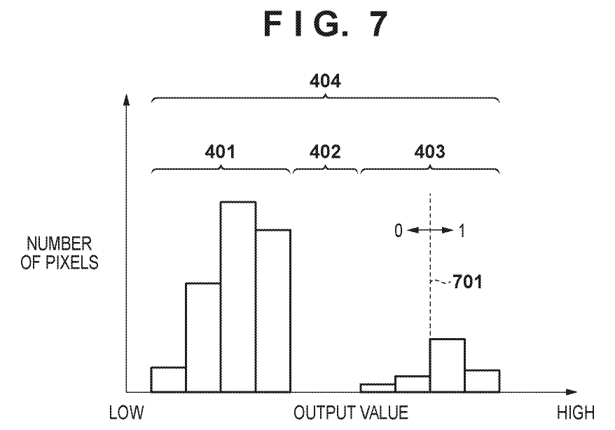

The radiation detector 100 according to the present embodiment can also be applied to the counting operation of performing binarization depending on whether radiation enters the pixels 103 arranged on the pixel array 102. FIG. 7 is a graph which is the same as the histogram of FIG. 4 except that it additionally includes the determination threshold 701 for binarizing the pixel signals output from the plurality of pixels 103. For example, the signal processing circuit 109 binarizes pixel signals, of the pixel signals output from the plurality of pixels 103, which are A/D-converted by using the ramp signal 603 by comparing the magnitudes of the pixel signals using the determination threshold 701. That is, the radiation detector 100 according to the present embodiment can perform binarization upon removing background components having simultaneity with imaging of an imaging target.

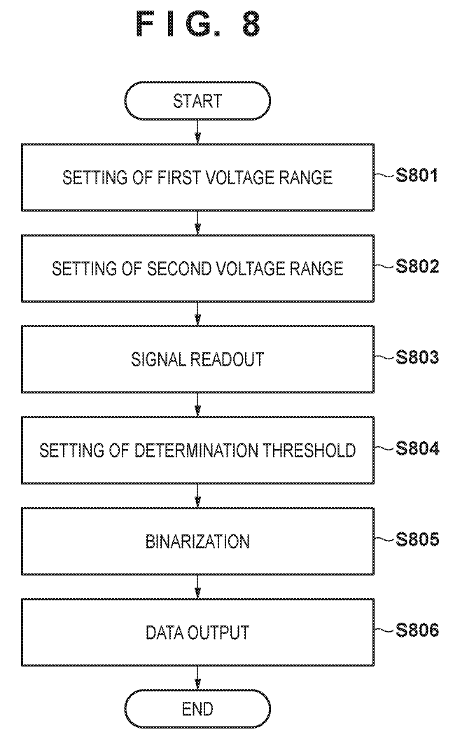

FIG. 8 is a flowchart showing the contents of the processing performed by the radiation detector 100 at the time of binarization. In step S801, the first voltage range 605 of the ramp signal 602 as a reference signal is set. In step S802, the second voltage range 607 of the ramp signal 603 as a reference signal is set. The first voltage range 605 and the second voltage range 607 may be set by using, for example, the image data obtained in advance by imaging. Alternatively, for example, the first voltage range 605 and the second voltage range 607 may be manually or automatically selected from a plurality of types of settings in accordance with radiation irradiation conditions. In addition, step S801 may be performed before step S802, or the first voltage range 605 and the second voltage range 607 may be set simultaneously.

At the time of imaging, electric charge is accumulated in each pixel 103 of the pixel array 102 while being irradiated with radiation from the radiation source of the radiation detection system incorporating the radiation detector 100. In step S803, a pixel signal is read out from each pixel 103 for each frame. In step S804, the determination threshold 701 is set. The determination threshold 701 may be acquired (calculated) from image data obtained in advance by imaging or acquired from image data obtained in real time in the latest frame. In step S805, the pixel signal A/D-converted by using the ramp signal 603 in the second voltage range 607 is binarized by using the determination threshold 701 set in step S804. In step S806, the binarized data of each pixel 103 is output to the outside from the radiation detector 100. Outputting the data binarized by the radiation detector 100 makes it possible to reduce the number of output ports of the radiation detector 100, reduce the output clock rate, and reduce the data throughput outside the radiation detector 100. This makes it possible to achieve reductions in the costs of the radiation detector 100 and the radiation detection system including the radiation detector 100.

As described above, the reference signal generating circuit 503 sets voltage ranges for A/D conversion in the high-speed mode in steps S801 and S802. Step S803 can be executed by the vertical scanning circuit 104, the horizontal scanning circuit 108, a control circuit that controls control timings with respect to these circuits, and the like. Steps S804 to S806 are executed by the signal processing circuit 109.

The present embodiment has exemplified the signal processing circuit 109 in the imaging unit 101 as a configuration for performing steps S804 to S806. That is, in the high-speed mode in the present embodiment, the imaging unit 101 can be made to have a function of deriving and removing background components in an on-chip form, that is, on the same substrate as that of the pixel array 102, the column signal processing circuit 106, and the like. This makes it possible to simplify the post-processing after the output signal processor 110. It is, therefore, possible to reduce the size and cost of the radiation detector 100. However, limitation is not made to this configuration, and background components may be derived and removed in steps S804 to S806 outside the imaging unit 101, for example, in the output signal processor 110. In addition, programs for causing the computer to execute some or all of steps S801, S802, and S804 to S806 may be stored in a non-transitory computer-readable storage medium and may be executed by the computer. This can improve the convenience for the user.

Changes in the signal levels of the ramp signals 602 and 603 as reference signals generated by the reference signal generating circuit 503 need not always be continuous but may be stepwise. In addition, a change in signal level need not always be linear with respect to the time and may be curvilinear with respect to the time. In addition, the voltage ranges of the ramp signals 602 and 603 may be further divided. The scheme of the A/D converter 500 is not limited to the Slope scheme, and a successive approximation type A/D converter or ΔΣ type converter can be used. Selecting voltage ranges for A/D conversion and resolutions in accordance with the idea of the present disclosure can obtain the effects of the present disclosure.

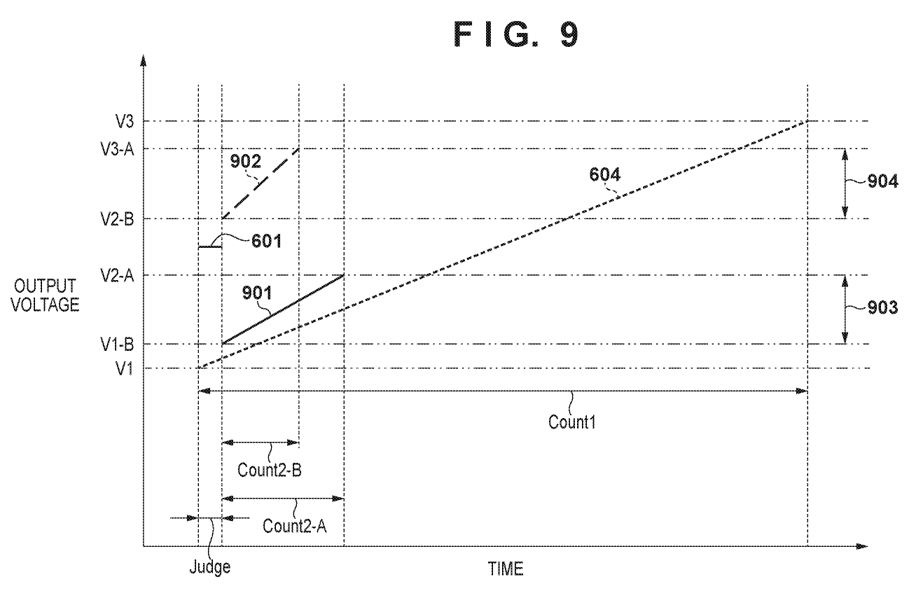

FIG. 9 shows a modification of a timing chart for explaining the operation of the reference signal generating circuit 503 shown in FIG. 6. The abscissa represents the time, and the ordinate represents the output voltage of the reference signal generating circuit 503. The operation shown in FIG. 9 differs from that shown in FIG. 6 in that the resolutions of a ramp signal 901 and a ramp signal 902 differ from those of the ramp signal 602 and the ramp signal 603. According to the operation shown in FIG. 6, the gradients of the changes in voltage of the ramp signals 602 and 603 used in the high-speed mode with respect to the time are the same as the gradient of the ramp signal 604 used in the normal mode. On the other hand, according to the operation shown in FIG. 9, the gradients of the changes in voltage of the ramp signals 901 and 902 used in the high-speed mode with respect to the time are different from the gradient of the ramp signal 604 used in the normal mode, and more specifically are larger than the gradient of the ramp signal 604. Accordingly, decreasing the resolutions by increasing the gradients of the changes in voltage of the ramp signals 901 and 902 with respect to the time makes it possible to perform A/D conversion in periods Count2-A and Count2-B shorter than the period Count2 shown in FIG. 6.

In addition, in the operation shown in FIG. 9, a first voltage range 903 of the ramp signal 901 and a second voltage range 904 of the ramp signal 902 are narrower than the first voltage range 605 of the ramp signal 602 and the second voltage range 607 of the ramp signal 603. This setting can be implemented by, for example, roughly acquiring the voltage ranges of a background component and an image signal component in advance. In a case where counting is performed, in particular, a background component may be acquired, and an A/D conversion value near the determination threshold 701 for counting may be obtained. Accordingly, narrowing the first voltage range 903 and the second voltage range 904 can implement fast A/D conversion.

In the operation shown in FIG. 9, the gradient (resolution) of the ramp signal 901 used in the high-speed mode is different from the gradient (resolution) of the ramp signal 902, although limitation is not made thereto. For example, the ramp signal 901 and the ramp signal 902 may sweep the voltages with almost the same resolution. Acquiring and subtracting a background component with a resolution equivalent to the A/D conversion value of the ramp signal 902 from the A/D conversion value of the ramp signal 901 makes it possible to subtract each A/D conversion value without gain adjustment.

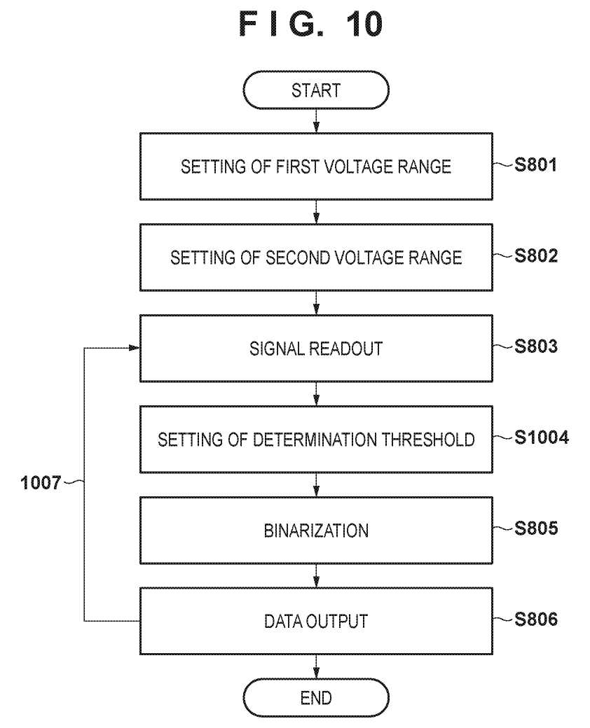

FIG. 10 is a flowchart showing a modification of the processing performed by the radiation detector 100 at the time of performing binarization described with reference to FIG. 8. A background component changes due to various reasons. One of the reasons is, for example, damage to the imaging apparatus caused by the cumulative radiation dose of radiation known as a total dose effect. More specifically, conceivable reasons include an increase in dark current in the pixel 103 and threshold variation in each transistor arranged in the pixel 103. That is, as the cumulative radiation dose increases, the first pixel signal range 401 shown in FIG. 4 may shift. Binarization processing with consideration of a total dose effect will be described below.

Each of steps S801 to S803 is the same as a corresponding one of the steps described above, in which the first voltage range 605 and the second voltage range 607 are set, and pixel signals are read out from the pixels 103. In step S1004, the determination threshold 701 shown in FIG. 7 is set from the background component read out with the ramp signal 602. For example, the signal processing circuit 109 sets the determination threshold 701 based on pixel signals, of the pixel signals output from the plurality of pixels 103, which are output from the plurality of pixels 103 in the same frame as a pixel signal to be binarized (a pixel signal to be A/D-converted by using the ramp signal 603) and are A/D-converted by using the ramp signal 602. For example, the signal processing circuit 109 may perform correction, such as removing a background component from the determination threshold 701 acquired from image data obtained in advance by imaging or image data obtained in the latest frame. Upon setting the determination threshold 701, the signal processing circuit 109 performs binarization processing in step S805 in the same manner as described above, and outputs the data of each pixel 103 in step S806.

The radiation detector 100 returns the process from step S806 to step S803 as indicated by a line 1007 upon execution of step S1006 and repeats step S803 to step S806, thereby setting the determination threshold 701 corresponding to an increase in the cumulative radiation dose. That is, even if the first pixel signal range 401 shifts, the radiation detector 100 according to the present embodiment can execute binarization processing following variation in background component by shifting the determination threshold 701 of the second pixel signal range 403 by the shift of the first pixel signal range 401.

As described above, a change in background component can be corrected by setting the determination threshold 701 from the background component obtained from a pixel signal A/D-converted by using the ramp signal 602. In this case, instead of shifting the determination threshold 701 in step S1004, the ramp signal 602 and the ramp signal 603 may be shifted by an amount equivalent to the change amount. In this case, subtracting the background component from the image signal component can eliminate an increase in cumulative radiation dose.

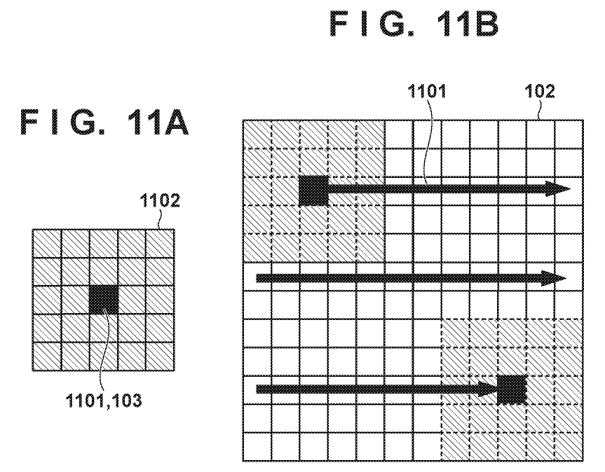

The next is a description of the processing (method) of reducing the influence of spatial non-uniformity in acquiring a background component. FIGS. 11A and 11B show an arithmetic filter according to the present embodiment. FIG. 11A shows the filter region of the arithmetic filter. According to the present embodiment, selecting a background component for each pixel makes it possible to obtain two-dimensional background components.

As shown in FIG. 11A, with respect to a target pixel 1101 (a pixel of interest) of the pixels 103, a predetermined range 1102 constituted by the plurality of pixels 103 around the target pixel 1101 is set as the size of the arithmetic filter. A background component is acquired from the value of the pixel signal output from each pixel 103 in the filter region of the arithmetic filter. The determination threshold 701 may be set by using this background component.

As shown in FIG. 11B, the target pixel 1101 is two-dimensionally swept by being sequentially shifted on the pixel array 102, and a background component is acquired for each pixel 103 by using an arithmetic filter with the predetermined range 1102 shown in FIG. 11A. The direction in which sweeping is performed first may be either the column direction or the row direction. For example, sweeping may be performed in the row direction or the column direction depending on, for example, the processing characteristics of the signal processing circuit 109.

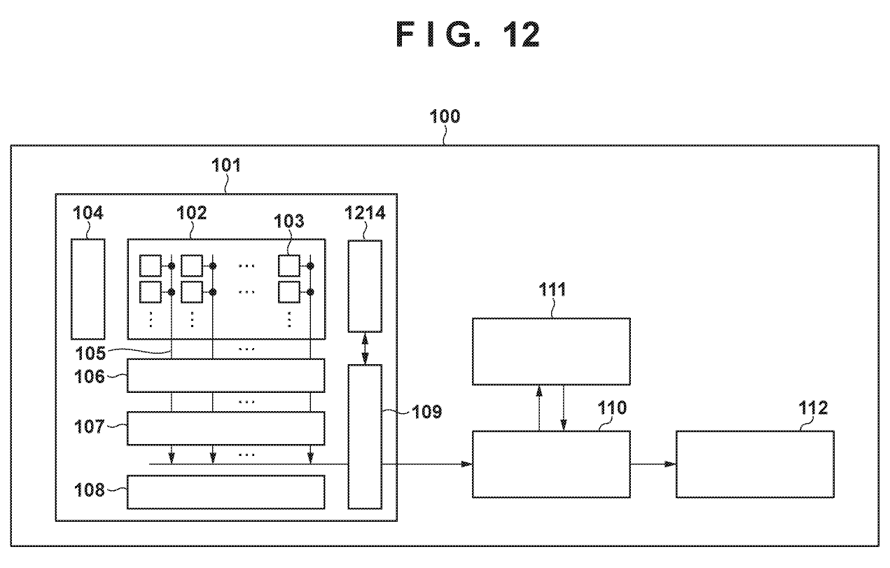

FIG. 12 shows a configuration example of the radiation detector 100 that acquires background components by using the arithmetic filter. As compared with the configuration shown in FIG. 1, this configuration example additionally includes a memory 1214. The remaining components may be the same as those shown in FIG. 1, and the configuration example will be described with focus on different points. Descriptions of similar portions will be omitted as appropriate.

In the present embodiment, the signal processing circuit 109 can execute processing with the arithmetic filter. A filter size (the predetermined range 1102) is set in consideration of a spatial frequency as a main factor that causes the non-uniformity of background components. In general, reducing the filter size makes it easy to extract local unevenness and shading components included in background components. In contrast to this, increasing the filter size will reduce the possibility that the value calculated as a background component will greatly deviate from the actual background component.

In a case where the filter size is large, the memory 1214 such as a line memory or frame memory may be provided in the imaging unit 101 of the radiation detector 100. The memory 1214 holds a pixel signal output from the pixel 103 in the predetermined range 1102 from the target pixel 1101 of the plurality of pixels 103 and A/D-converted by using the ramp signal 602. The signal processing circuit 109 sets the determination threshold 701 based on the pixel signal held by the memory 1214. In a case where a frame memory is provided as the memory 1214, a background component can be calculated by using a two-dimensional filter. Using the two-dimensional filter makes it possible to accurately calculate a background component while suppressing the influence of characteristic variation unique to a signal component other than a background component or a pixel. In addition, as described above, performing processing inside the radiation detector 100 will improve the simultaneity between imaging and correction processing. In contrast to this, in a case where a line memory is provided as the memory 1214, a background component is calculated by using a one-dimensional filter. However, the memory size can be reduced. This makes it possible to reduce the size of the radiation detector 100 (the imaging unit 101).

The memory 1214 need not always be provided in the imaging unit 101. The memory 1214 may be provided outside the imaging unit 101. For example, the output signal processor 110 may be provided with the memory 1214 and perform the above processing.

As described above, acquiring a background component for each pixel 103 by using the arithmetic filter can acquire background components including a spatially non-uniform distribution. This makes it possible to improve the accuracy of image data after the subtraction of background components.

A background component can include non-uniformity for each pixel. In order to correct non-uniformity for each pixel, for example, an output for each pixel without irradiation with radiation may be acquired in advance as a correction value, and the correction value may be subtracted from a pixel signal at the time of imaging. A method of acquiring a background component in the present embodiment may be used in combination with such a method of correcting an output for each pixel.

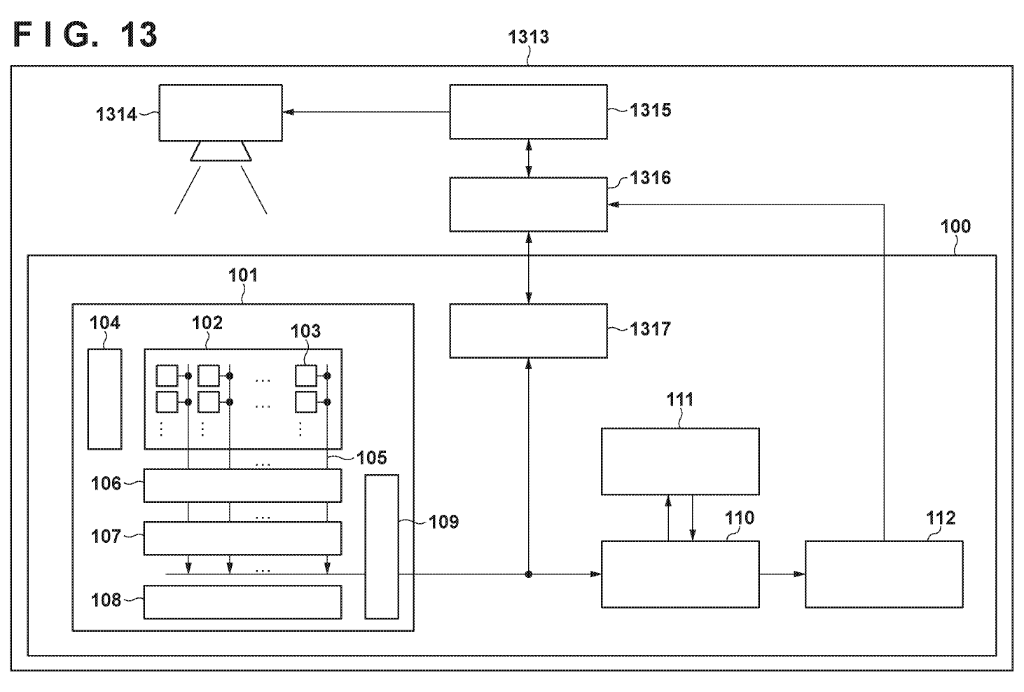

FIG. 13 shows a configuration example of a radiation detection system 1313 incorporating the radiation detector 100 according to the present embodiment. The radiation detection system 1313 can include the radiation detector 100, a radiation source 1314 that irradiates the radiation detector 100 with radiation, an exposure controller 1315, and a computer 1316.

The radiation source 1314 starts to apply radiation in accordance with an exposure command supplied from the exposure controller 1315. The radiation emitted from the radiation source 1314 enters the imaging unit 101 of the radiation detector 100 directly or indirectly through an imaging target. The radiation source 1314 stops applying radiation in accordance with a stop command supplied from the exposure controller 1315.

The radiation detector 100 includes a controller 1317 that controls the frame rate of imaging and the irradiation rate of radiation. The controller 1317 may generate a stop signal for stopping the emission of radiation from the radiation source 1314 based on the signal output from the imaging unit 101. The stop signal is supplied to the exposure controller 1315. The exposure controller 1315 sends a stop command to the radiation source 1314 in response to the stop signal.

In executing the above binarization processing, even if radiation is detected twice or more at one pixel 103 in one frame, "1" is output as an binarized output. For this reason, the image signal component is partly omitted. Accordingly, for example, the controller 1317 controls the frame rate of imaging and the irradiation rate of radiation such that the irradiation rate of radiation does not exceed 0.5/pix/frm. For example, performing imaging at a relatively low irradiation rate makes it possible to provide an image with an improvement in count loss at the time of counting.

In this case, the unit [/pix/frm] is the average value of the numbers of particles or photons of radiation entering per frame and pixel. In the present embodiment, the irradiation rate of radiation is 0.5/pix/frm or less. In other words, the radiation source 1314 is controlled at a low irradiation rate such that the probability that radiation enters the one pixel 103 at a given time becomes 0.5 or less. A reference irradiation rate in the use of X-rays is 0.5 or less in terms of the average value of the numbers of photons entering per frame and pixel. A reference irradiation rate in the use of electron beams is 0.5 or less in terms of the average value of the numbers of electrons entering per frame and pixel.

The controller 1317 may be, for example, a programmable logic device (PLD) such as a field programmable gate array (FPGA) or an application specific integrated circuit (ASIC). Alternatively, the controller 1317 may be general-purpose computer incorporating programs. Alternatively, the controller 1317 may be a combination of all or some of these components.

The computer 1316 may control, for example, the radiation detector 100 and the exposure controller 1315. The computer 1316 may perform the processing of receiving radiation image data from the external I/F UNIT 112 and displaying the data as a radiation image.

In this case, the controller 1317 may be provided independently of the radiation detector 100. For example, the computer 1316 may have the function of the controller 1317. In addition, the computer 1316 may function as an input unit with which the user inputs conditions for imaging to obtain radiation images.

For example, the exposure controller 1315 has an exposure switch. When the user turns on the exposure switch, the exposure controller 1315 sends an exposure command to the radiation source 1314 and also sends a start notification indicating the start of irradiation with radiation to the computer 1316. Upon receiving the start notification, the computer 1316 notifies the controller 1317 of the radiation detector 100 of the start of irradiation with radiation in response to the start notification. In accordance with this operation, the controller 1317 causes the imaging unit 101 to generate a signal corresponding to the incident radiation.

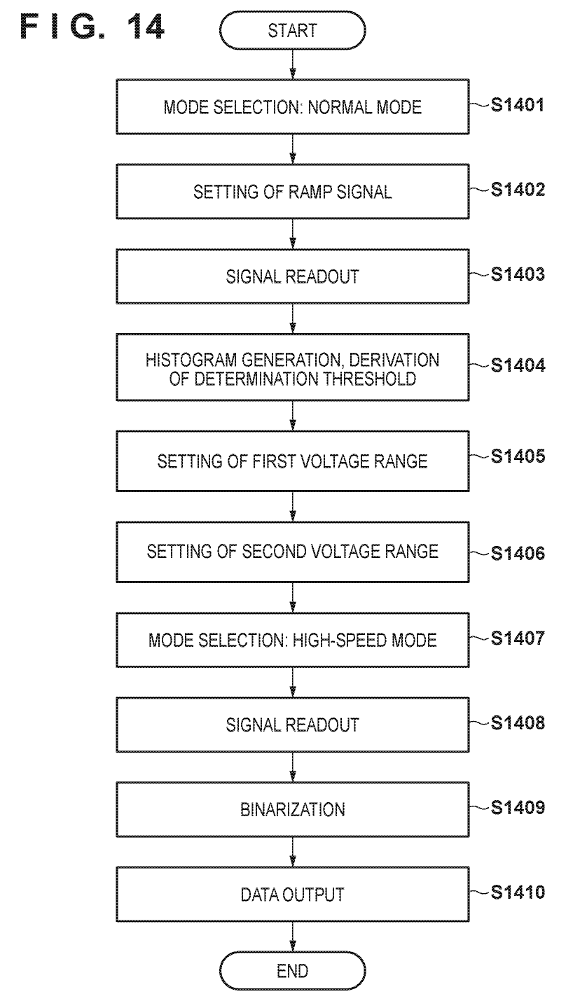

FIG. 14 is a flowchart showing the contents of processing performed by the radiation detector 100 incorporated in the radiation detection system 1313. In the operation shown in FIG. 14, the operation in steps S1401 to S1406 is performed before imaging (actual imaging) in the high-speed mode described above. In step S1401, the A/D converter 500 is set to the normal mode. In step S1402, the ramp signal 602 is set. At the time of imaging, while the radiation source 1314 of the radiation detection system 1313 emits radiation, electric charge is accumulated in each pixel 103 of the pixel array 102. In step S1403, a pixel signal is read out from each pixel 103 for each frame. In step S1404, the histogram shown in FIG. 4 is generated, and the mode value of the histogram and the determination threshold 701 are derived. In step S1405, the first voltage range 605 of the ramp signal 602 is set in a range including the mode value of the histogram. In step S1406, the second voltage range 607 of the ramp signal 603 is set in a range including the determination threshold 701. Step S1406 may be executed before step S1405, or steps S1405 and S1406 may be executed concurrently.

Steps S1407 to S1410 indicate an operation in actual imaging. In step S1407, the A/D converter 500 is set to the high-speed mode. At the time of imaging, while the radiation source 1314 of the radiation detection system 1313 emits radiation, electric charge is accumulated in each pixel 103 of the pixel array 102. In step S1408, a pixel signal is read out from each pixel 103 for each frame. In step S1409, for example, the mode value of the histogram shown in FIG. 4 is set as a background component, and a signal component is binarized by using the determination threshold 701 set in step S1404. In step S1410, each pixel 103 outputs binarized data.

In the present embodiment, in steps S1401 and S1407, modes are set in the A/D converter 500. In steps S1402, S1405, and S1406, the reference signal generating circuit 503 sets voltage ranges for A/D conversion. Steps S1403 and S1408 can be executed by, for example, the vertical scanning circuit 104, the horizontal scanning circuit 108, and the control circuit that controls control timings with respect to them. Steps S1404, S1409, and S1410 are executed by the signal processing circuit 109.

In the present embodiment, the first voltage range 605 of the ramp signal 602 set in step S1405 is optimized by using the result of preliminary imaging in steps S1401 to S1404. In the present embodiment, the first voltage range 605 of the ramp signal 602 is set so as to include the mode value of the histogram shown in FIG. 4. Using the mode value can reduce the influence of an output value from a pixel deviating from the voltage range on the image quality of an obtained image, although limitation is not made thereto. A median value may be derived instead of the mode value of the pixel signals output from the pixels 103 in step S1404, and the first voltage range 605 of the ramp signal 602 may be set so as to include the median value of the histogram. The method of calculating a median value may use a known algorithm. For example, in a case where the median value of pixel signals is calculated for each row, pixel signals of each row may be sorted in descending order by quick sorting, and a value at the intermediate position may be selected from a sorted list. Alternatively, for example, a faster algorithm known as Quickselect may be used. Alternatively, for example, the average value of pixel signals output from the pixels 103 may be derived in step S1404, and the first voltage range 605 of the ramp signal 602 may be set so as to include the average value of the histogram.

An element other than the imaging unit 101 of the radiation detector 100 may perform the generation of the histogram shown in FIG. 14, the derivation of the mode value of the histogram, the derivation of the determination threshold 701, and binarization processing. For example, the output signal processor 110 may perform the processing in steps S1404, S1409, and S1410. Alternatively, the mode value of a histogram can be derived from image data obtained in advance by imaging or derived from the latest image data obtained in real time.

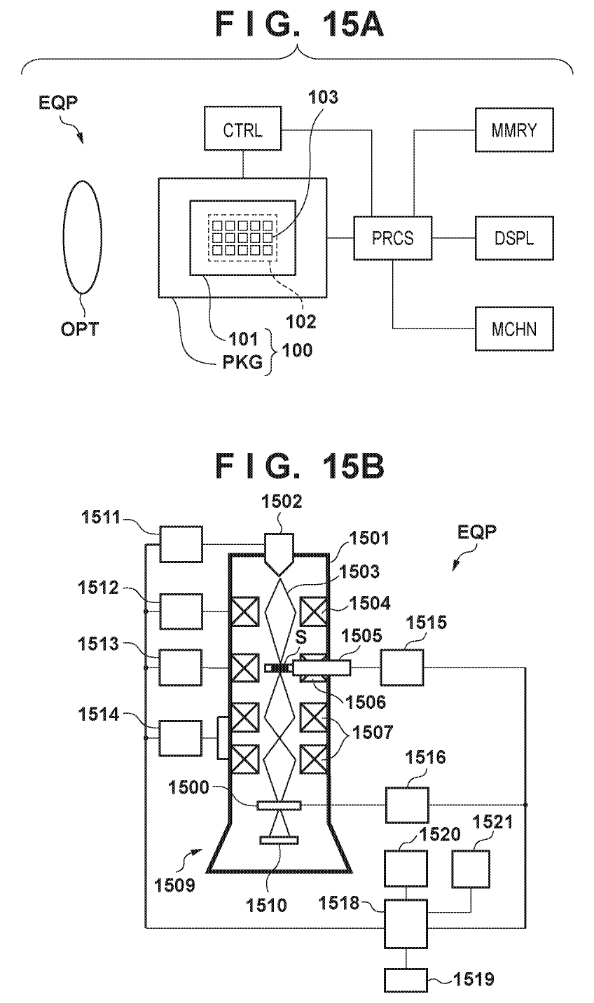

Other examples of the radiation detection system incorporating the radiation detector 100 will be described next with reference to FIGS. 15A and 15B.

FIG. 15A shows equipment EQP as a detection system including the radiation detector 100. The radiation detector 100 includes the imaging unit 101 as a semiconductor device and a package PKG for implementing the imaging unit 101.

The package PKG can include a base to which the imaging unit 101 is fixed, a lid such as glass facing the imaging unit 101, and a connecting member such as a bonding wire or bump used to connect a terminal provided on the base to a terminal provided on the imaging unit 101. The imaging unit 101 includes a pixel array 102 where the pixels 103 are arrayed in a matrix and a peripheral region around the pixel array 102. The peripheral region can be provided with peripheral circuits (for example, the vertical scanning circuit 104, and the signal processing circuit 109 and the like).

The equipment EQP can further include at least one of an optical system OPT, a control device CTRL, a processing device PRCS, a display device DSPL, a storage device MMRY, and a mechanical device MCHN. The optical system OPT forms an image of radiation on the radiation detector 100, and is, for example, a lens, a shutter, and a mirror. The optical system OPT may form an image of a particle beam such as an electron beam or a proton beam on the radiation detector 100 in accordance with the kind of radiation to be processed. The control device CTRL controls the radiation detector 100, and is, for example, an ASIC. The processing device PRCS processes a signal output from the radiation detector 100, and is, for example, a device such as a CPU or an ASIC for forming an Analog Front End (AFE) or a Digital Front End (DFE). The display device DSPL is an EL display device or a liquid crystal display device that displays, in a format such as a visible image, information obtained by the radiation detector 100. The storage device MMRY is a magnetic device or a semiconductor device for storing information obtained by the radiation detector 100. The storage device MMRY is a volatile memory such as an SRAM or a DRAM or a nonvolatile memory such as a flash memory or a hard disk drive. The mechanical device MCHN includes a moving or propulsion unit such as a motor or an engine.

In the equipment EQP, a signal output from the radiation detector 100 is displayed on the display device DSPL, or transmitted to an external device by a communication device (not shown) included in the equipment EQP. Hence, the equipment EQP may further include the storage device MMRY and the processing device PRCS in addition to a storage circuit and an arithmetic circuit included in the radiation detector 100. The mechanical device MCHN may be controlled based on the signal output from the radiation detector 100.

The equipment EQP shown in FIG. 15A may be medical equipment such as an endoscope or radiation diagnostic equipment, measurement equipment such as a distance measurement sensor, or analysis equipment such as an electron microscope.

FIG. 15B is a schematic view showing the configuration of a Transmission Electron Microscope (TEM) as an example of the equipment EQP. The equipment EQP serving as an electron microscope includes an electron beam source 1502 (electron gun), an irradiation lens 1504, a vacuum chamber 1501 (lens barrel), an object lens 1506, a magnifying lens system 1507, and a camera 1509 serving as the radiation detector 100.

An electron beam 1503 as an energy beam emitted from the electron beam source 1502 is focused by the irradiation lens 1504, and irradiates a sample S as an analysis target held by a sample holder. A space through which the electron beam 1503 passes is formed by the vacuum chamber 1501 (lens barrel), and is held in vacuum. The radiation detector 100 is arranged to face the vacuum space through which the electron beam 1503 passes. The electron beam 1503 transmitted through the sample S is magnified by the object lens 1506 and the magnifying lens system 1507, and projected onto the radiation detector 100. An electron optical system for irradiating the sample S with an electron beam is called an irradiation optical system, and an electron optical system for forming an image of the electron beam transmitted through the sample S on the radiation detector 100 is called an imaging optical system.

The electron beam source 1502 is controlled by an electron beam source control device 1511. The irradiation lens 1504 is controlled by an irradiation lens control device 1512. The object lens 1506 is controlled by an object lens control device 1513. The magnifying lens system 1507 is controlled by a magnifying lens system control device 1514. A control mechanism 1505 of the sample holder is controlled by a holder control device 1515 configured to control a driving mechanism of the sample holder.

The electron beam 1503 transmitted through the sample S is detected by a direct electron detector 1500 of the camera 1509. A signal output from the direct electron detector 1500 is processed by a signal processing device 1516 and an image processing device 1518 serving as the processing device PRCS, thereby generating an image signal. The generated image signal (transmission electron image) is displayed on an image display monitor 1520 and an analysis monitor 1521 corresponding to the display device DSPL.

The camera 1509 is provided in the lower portion of the equipment EQP. The camera 1509 includes the direct electron detector 1500. The direct electron detector 1500 corresponds to the imaging unit 101. At least part of the camera 1509 is provided in the camera 1509 so as to be exposed to the vacuum space formed by the vacuum chamber 1501.

Each of the electron beam source control device 1511, the irradiation lens control device 1512, the object lens control device 1513, the magnifying lens system control device 1514, and the holder control device 1515 is connected to the image processing device 1518. This allows them to exchange data in order to set the imaging condition of the electron microscope. For example, an electron beam irradiation rate can be set to be 0.5 electron/pix/frm or less. In this case, the electron beam source control device 1511 and the image processing device 1518 function as a control means for controlling a radiation irradiation rate. By a signal from the image processing device 1518, driving control of the sample holder and setting of the observation condition of each lens can be performed.

An operator prepares the sample S as an imaging target, and sets imaging conditions using an input device 1519 connected to the image processing device 1518. Predetermined data is input to each of the electron beam source control device 1511, the irradiation lens control device 1512, the object lens control device 1513, and the magnifying lens system control device 1514 to obtain a desired acceleration voltage, magnification, and observation mode. Furthermore, the operator inputs conditions such as the number of continuous visual field images, an imaging start position, and the moving speed of the sample holder to the image processing device 1518 using the input device 1519 such as a mouse, a keyboard, and a touch panel. The image processing device 1518 may automatically set the conditions regardless of the operator input. The radiation detection system described above is by way of example only, and the radiation detector 100 described above may be applied to other systems.

The above embodiment has exemplified the case where the technique of obtaining background components of pixel signals concurrently with imaging is applied to the radiation detector or the radiation detection system, although limitation is not made thereto. For example, the technique described in each embodiment may be applied to an imaging apparatus using a single photon avalanche diode (SPAD) and an imaging system including the imaging apparatus. This makes it possible to obtain background components having simultaneity with imaging and remove the background components from image data.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processor (CPU), micro processor (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

The present disclosure can provide a technique advantageous in improving the image quality of a radiation image.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-062550, filed Apr. 4, 2025, which is hereby incorporated by reference herein in its entirety.

What is claimed is:

1. A radiation detector comprising a plurality of pixels configured to output pixel signals in accordance with incident radiation and an A/D converter configured to A/D-convert the pixel signals,
wherein the A/D converter includes a comparator configured to compare the pixel signal with a signal threshold and is configured to operate in a plurality of modes,
the plurality of modes includes a first mode of performing A/D conversion of the pixel signal by using a first reference signal in a case where the pixel signal is smaller than the signal threshold and performing A/D conversion of the pixel signal by using a second reference signal in a case where the pixel signal is larger than the signal threshold,
the first reference signal is a signal that temporally changes in a first voltage range, and the second reference signal is a signal that temporally changes in a second voltage range,
an upper limit value of the first voltage range is smaller than a lower limit value of the second voltage range, and
the signal threshold is set between the upper limit value and the lower limit value.

2. The detector according to claim 1, wherein a third voltage range in which no A/D conversion is performed is present between the first voltage range and the second voltage range in the first mode,
an upper limit value of the third voltage range is not more than the lower limit value of the second voltage range, and
a lower limit value of the third voltage range is not less than the upper limit value of the first voltage range.

3. The detector according to claim 1, wherein a gradient of a change in voltage of the first reference signal with respect to the time is equal to a gradient of a change in voltage of the second reference signal with respect to the time.

4. The detector according to claim 1, wherein a gradient of a change in voltage of the first reference signal with respect to the time is different from a gradient of a change in voltage of the second reference signal with respect to the time.

5. The detector according to claim 1, wherein the plurality of modes include a second mode of performing A/D conversion of the pixel signal by using a third reference signal, and
the third reference signal is a signal that temporally changes in a continuous fourth voltage range including the first voltage range and the second voltage range.

6. The detector according to claim 5, wherein the gradient of a change in voltage of at least one of the first reference signal and the second reference signal with respect to the time is equal to the gradient of a change in voltage of the third reference signal with respect to the time.

7. The detector according to claim 5, wherein the gradients of changes in voltage of the first reference signal and the second reference signal with respect to the time are larger than the gradient in a change in voltage of the third reference signal with respect to the time.

8. The detector according to claim 1, further comprising a processing circuit configured to process a signal A/D-converted by the A/D converter,
wherein the processing circuit binarizes a pixel signal, of the pixel signals output from the plurality of pixels, which is A/D-converted by using the second reference signal by using a determination threshold.

9. The detector according to claim 8, wherein the processing circuit sets the determination threshold based on first pixel signals, of the pixel signals output from the plurality of pixels, which are output from the plurality of pixels in the same frame as a frame of a pixel signal to be binarized and A/D-converted by using the first reference signal of the pixel signals.

10. The detector according to claim 9, wherein the processing circuit sets the determination threshold based on the first pixel signal output from a pixel in a predetermined range from a pixel, of the plurality of pixels, which outputs a pixel signal to be binarized and A/D-converted by using the first reference signal.

11. The detector according to claim 10, further comprising a frame memory configured to hold the first pixel signal,
wherein the processing circuit sets the determination threshold based on the first pixel signal held in the frame memory.

12. The detector according to claim 10, further comprising a line memory configured to hold the first pixel signal,
wherein the processing circuit sets the determination threshold based on the first pixel signal held in the line memory.

13. The detector according to claim 1, further comprising a processing circuit configured to process a signal A/D-converted by the A/D converter,
wherein the processing circuit corrects a pixel signal, of the pixel signals output from the plurality of pixels in one frame, which is A/D-converted by using the second reference signal based on a pixel signal A/D-converted by using the first reference signal.

14. The detector according to claim 1, wherein the first voltage range is set so as to include a mode value, a median value, or an average value of the pixel signals output from the plurality of pixels.

15. A radiation detection system comprising:
the radiation detector according to claim 1; and
a radiation source configured to irradiate the radiation detector with radiation.

16. The system according to claim 15, wherein a radiation irradiation rate of the radiation source is controlled such that an average value of photons or particles of incident radiation per frame and pixel becomes not more than 0.5.
